(19) United States
(12) Patent Application Publication
(10) Pub. No.: US 2003/0083838 A1
(43) Pub. Date: May 1, 2003

(54) Wireless test and measurement method

(76) Inventors: Richard M. Barrett, Chelmsford, MA (US); Gregory J. Dinning, Westford, MA (US); Jonathan M. Miller, Holliston, MA (US); Richard J. Brody, Clinton, MA (US)

Correspondence Address: AGILENT TECHNOLOGIES, INC., INTELLECTUAL PROPERTY ADMINISTRATION, LEGAL DEPT., P.O. BOX 7599, M/S DL429, LOVELAND, CO, 80537-0599, US

(21) Appl. No.: 09/682,917

(22) Filed: Oct. 31, 2001

(51) Int. Cl. G06F 19/00

(52) U.S. Cl. 702/117

(57) ABSTRACT

A remote test and measurement system including a test head that analyzes characteristics of a communication line and reports the results via a network. A server interfaces with the test head, via the network, and sends and receives commands and data therewith. A interface device interfaces with the server via the network. The interface device issues commands to the test head and receives data from the test head via the server.

### BACKGROUND OF INVENTION

Service and support is a vital function in the communication and networking fields. Many organizations, such as telephone companies, have set up elaborate test and measurement systems to ensure their customers have a certain level and quality of service. However, many of these system are based on a hundred year old paradigm of sending a service truck to the site to diagnose the reported problem.

FIG. 1 is a system diagram illustrating a current test and measurement system 100 for the telecommunications industry. When a subscriber or customer initiates a service call to a customer support desk 102, an administrator attempts to resolve the reported trouble using system test procedures 104, typically accessed through a network 106. Such system tests 104 have about a 90% success rate. If the system test 104 is unable to resolve the problem to the customer's satisfaction, a trouble ticket is generated by a trouble ticket application 108. In response to a first trouble ticket, a tier one technician 110 is dispatched, to the trouble site in what is typically referred to as a “truck roll” and indicated, in FIG. 1, using a truck symbol.

The trouble ticket supplied to the tier one technician 110 typically includes narratives indicating the type of trouble reported and detected, as well as customer information relative to the dispatch. It is up to the tier one technician 110 to interpret the problem and identify the proper course of action. Upon arrival, the technician 110 connects a test device, often referred to as a “test head,” to the telecommunications line. Known test heads include various electronic circuits for coupling with the line under test allowing the technician to perform various tests on the line. Some examples of known test heads include the SERVICE ADVISOR TEST TABLET distributed by AGILENT TECHNOLOGIES, INC. Once the test head is connected, the tier one technician 110 requests on-demand tests and conditions from a central office location which provides various test conditions over the telecommunications line to be tested, i.e., the “line under test”. It usually takes some time for the central office to set up the tests and conditions, during which time the tier one technician 110 is forced to wait. Based on the values output by the test head, the tier one technician 110 takes corrective action and re-tests the line under test.

Historically, tier one technicians have a 50% success rate. If the tier one technician 110 is unable to resolve the problem, a second trouble ticket is issued requesting the dispatch of a tier two technician 112. Tier two technicians 112 are more trained and experienced than tier one technicians 112 and, not coincidentally, are more expensive. Similarly, if the tier two technician 112 is unable to resolve the problem, a third trouble ticket is issued requesting the dispatch of a tier three technician 114 who have even more training and experience (and are even more expensive that a tier two technician). A tier three technician 114 will typically work on the problem until it is solved.

Overall, once the decision is made to roll a truck, problems take an average of 2.5 truck rolls to solve, with each truck roll costing between $750.00 and $1,500.00. Such costs are disadvantages in view of the tremendous competition in the telecommunications industry. Further, due to continuous reductions in the work force the number of qualified technicians is decreasing. Not only must technicians be trained to use test heads, they are also required to have a substantial knowledge of ever-changing subscriber loop and other test and measurement systems in order to carry out various tests on the line. Without proper knowledge, technicians often attempt ineffective solutions to the trouble report such as the swapping of line cards, cutting to clear, etc, when other, less drastic, solutions are available. This, of course, leads to an increased number of truck rolls further decreasing the overall efficiency of the system.

The present invention enables a test and measurement system that provides for the remote diagnosis of problems thereby reducing truck rolls.

### BRIEF DESCRIPTION OF DRAWINGS

An understanding of the present invention can be gained from the following detailed description, taken in conjunction with the accompanying drawings of which:

FIG. 1 is a system diagram illustrating a current test and measurement system for the telecommunications industry.

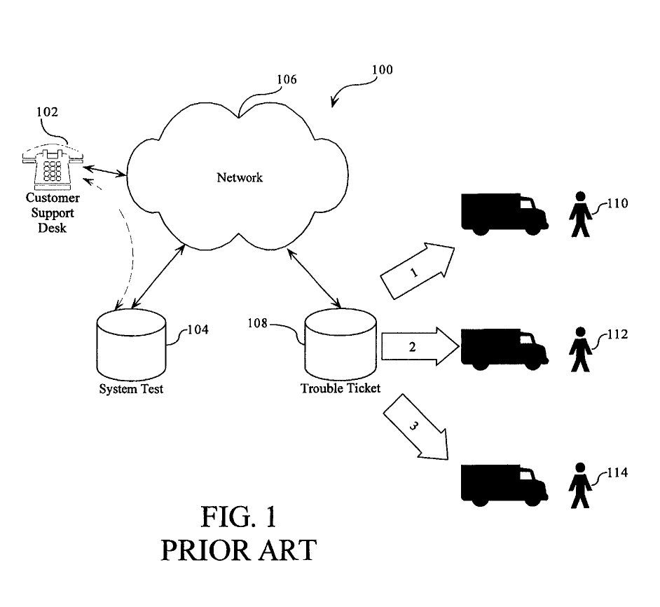

FIG. 2 is a system diagram of a test and measurement system in accordance with a preferred embodiment of the present invention.

FIG. 3 is a flowchart depicting a test and measurement procedure, in accordance with a preferred embodiment of the present invention, for use with the test and measurement system shown in FIG. 2.

FIG. 4 is a block diagram of a network ready test head in accordance with a preferred embodiment of the present invention.

FIG. 5 is a flowchart depicting a test and measurement procedure in accordance with a preferred embodiment of the present invention.

FIG. 6 is a flowchart depicting a test and measurement procedure in accordance with a preferred embodiment of the present invention.

FIG. 7 is a system diagram of a test and measurement system in accordance with a preferred embodiment of the present invention.

FIG. 8 is a system diagram of a test and measurement system in accordance with a preferred embodiment of the present invention.

FIG. 9 is a system diagram of a test and measurement system in accordance with a preferred embodiment of the present invention.

FIG. 10 is a block diagram of a test and measurement system in accordance with a preferred embodiment of the system

### DETAILED DESCRIPTION

Reference will now be made in detail to the present invention, examples of which are illustrated in the accompanying drawings, wherein like reference numerals refer to like elements throughout.

In general, the present invention relates to apparatus and method steps embodied in software and associated hardware configured to store and/or process electrical or other physical signals to generate other desired physical signals. Accordingly, the detailed description which follows contains descriptions of methods presented in terms of functions describing operations of data transfixed in a computer readable medium such as RAM, ROM, programmable logic arrays, ASICs, CD-ROM, DVD, hard disk, floppy disk, a data communication channel such as USB, SCSI, or FIREWIRE, and/or a network such as the Internet, or a LAN. These descriptions and representations are the means used by those skilled in the art effectively convey the substance of their work to others skilled in the art. Thus, many of the methods are comprised of a series of operations performed by one or more processors and, as such, are generally identified by such terms of art as “software,” “program,” “objects,” “functions,” “subroutines,” and “procedures.” In general, the sequence of steps in the methods of the present invention require physical manipulation of data representing physical quantities. Usually, though not necessarily, such data takes the form of electrical or magnetic signals capable of being stored, transferred, combined, compared or otherwise manipulated. Those of ordinary skill in the art conveniently refer to these signals as “data”, “bits”, “values”, “elements”, “symbols”, “characters”, “images”, “terms”, “numbers”, or the like. It should be recognized that these and similar terms are to be associated with the appropriate physical quantities they represent and are merely convenient labels applied to such quantities.

Unless otherwise noted, the methods recited herein may be enabled by a general purpose computer or other network device selectively activated or reconfigured by firmware or software. In particular, various devices from various vendors may be used with routines in accordance with the teachings herein, or it may prove more convenient to construct more specialized apparatus to perform the required method steps. In certain circumstances, when it is desirable that a piece of hardware possess certain characteristics, these characteristics are described more fully in the following text. The required structures for a variety of these machines may appear in the description given below. Devices and systems which may perform certain of the functions of the present invention include those manufactured by such companies as AGILENT TECHNOLOGIES INC., HEWLETT-PACKARD, DELL, CISCO, APPLE, and COMPAQ as well as other manufacturers of computing and test and measurement equipment.

With respect to the software described herein, those of ordinary skill in the art will recognize that there exists a variety of platforms and languages for creating software for performing the procedures outlined herein. Those of ordinary skill in the art also recognize that the choice of the exact platform and language is often dictated by the specifics of the actual system constructed, such that what may work for one type of system may not be efficient on another system. Generally, it is advantageous to employ a development system that produces application software compatible with one of the MICROSOFT WINDOWS operating systems such as NT, XP, CE, POCKET PC 2002, although other operating systems are within the scope of the invention, such as LINUX, UNIX, and OSX.

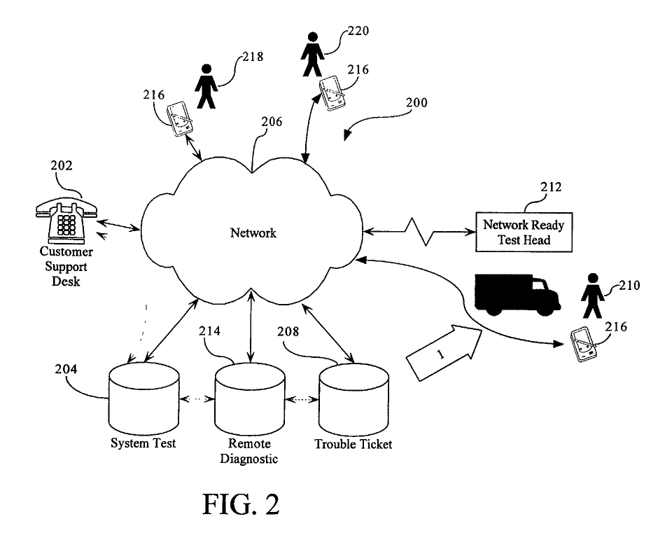

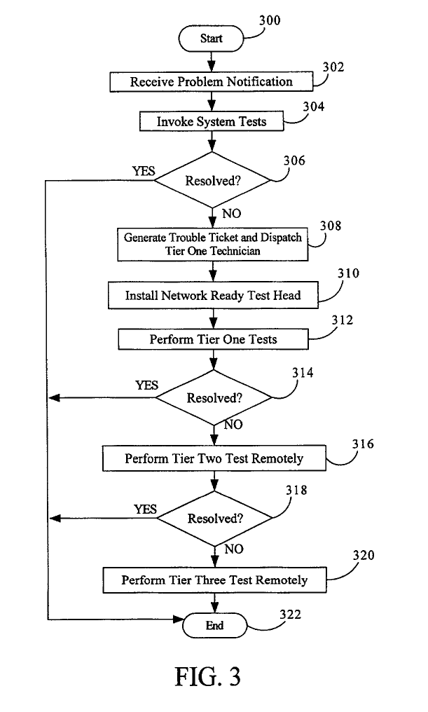

FIG. 2 is a system diagram of a test and measurement system 200 in accordance with a preferred embodiment of the present invention. FIG. 3 is a flowchart depicting a test and measurement procedure, in accordance with a preferred embodiment of the present invention, applicable to the test and measurement system 200 shown in FIG. 2. It will be appreciated by those of ordinary skill in the relevant arts that the measurement system 200, as illustrated in FIG. 2, and the operation thereof as illustrated in FIG. 3 is intended to be generally representative such systems. A specific instance of such a system may differ from that shown in FIGS. 2 and 3, particularly in the details of construction and operation of such system, yet still be within the scope of invention and more importantly within the scope of the claims. As such, the test and measurement system 200 and method of use thereof is to be regarded as illustrative and exemplary and not limiting as regards the invention described herein or the claims attached hereto.

The method starts in step 300 when a subscriber or customer initiates a service call received by customer support desk 202 in step 302. Next, in step 304, a representative attempts to resolve the reported trouble using system tests 204, typically accessed through a network 206. As previously noted, such system tests 204 have about a 90% success rate. If, in step 306, the system test 204 is unable to resolve the problem to the customer's satisfaction, a trouble ticket is generated by a trouble ticket application 208 leading to the dispatch a tier one technician 210, at step 308, to the trouble site. In step 310, the tier one technician 210 installs a network ready test head 212. It is understood that while the test and measurement system 200 is shown with only one network ready test head 212, it is within the scope of the present invention that multiple network ready tests connected to a plurality of communication lines will be in concurrent use.

In accordance with one preferred embodiment, the network ready test head 212 may be any one of a number of existing test heads, such as the AGILENT SERVICE ADVISOR TEST TABLET with the addition of any one of a variety of known network interfaces. Preferably, the network interface is wireless, but it may be wire based. Some possible communication options include: wireline Ethernet, wireless Ethernet, serial or parallel wireline, CDMA, BLUETOOTH, CDPD, GRPS, satellite, etc. . . . In accordance with one preferred embodiment of the present invention, the network ready test head 212 is adapted to receive data, commands and configuration parameters from a remote diagnostic application 214, via the network 206. Such commands and configuration parameters can modify or change the test and measurement functions stored in the network ready test head 212. The test head 212 subsequently transmits test results back to the network 206. It is understood that while the test and measurement system 200 is shown with only one network ready test head 212, it is within the scope of the present invention that multiple network ready tests will be in concurrent use.

Generally, the customer support desk 202, the system tests 204, the remote diagnostic application 214, and the trouble ticket application 208 are part of the “central office.” It is to be further understood that the system tests 204, the remote diagnostic application 214, and the trouble ticket application 208 are shown in logical form and may in fact all be resident on the same physical computer system or they may be distributed on different computer systems at different locations.

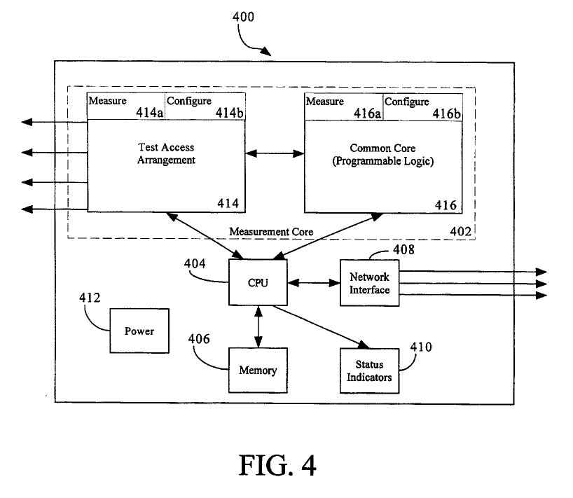

FIG. 4 is a block diagram of a network ready test head 400 in accordance with a preferred embodiment of the present invention. The test head 400 provides additional capabilities and enjoys different economies than utilizing an existing test head modified for network access. The test head 400 generally comprises: a measurement core 402; a CPU 404; a memory 406; a network interface 408; status indicators 410; and a power supply 412.

The power supply 412 preferably comprises an external power supply selected for interfacing with a local power source, for example a three-pronged 120 volt outlet, and a battery backup that provides enough power to perform certain pre-defined functions in the event of an interruption of power from the local power source. Such pre-defined functions can include sending a message indicating the power outage via the network interface 408. Status indicators 410 are preferably LEDs indicating the functionality of the test head 400, including for example, a power indicator (whether local source or battery), connection indicators for the measurement core 402 and the network interface 408, and perhaps a self test indication.

The network interface 408 provides a communication link between the test head 400 and a network such as the network 206 shown in FIG. 2. Specifically, the network interface may generally comprises at least one network interface card facilitating communication via any of a number of physical layers and network protocols, such as 802.11; CDMA; TCP/IP; Token Ring; Ethernet; SONET; USB; FIREWIRE; BLUETOOTH, etc. . . . It may be preferable that the network interface 408 be configured to interface with a plurality of networks to ensure the ability to communicate even if one mode of communication is interrupted. It may be further preferable that the network interface 408 be provided with a http server and a http client to facilitate communication with the network 206.

The CPU 404 and the memory 406 function together to provide overall control and timing for the test head 400. The CPU can be any of a variety of processing devices including any number of processors based on the PowerPC architecture and processors produced by MicroChip and Analog Devices. Further, depending on the configuration of the network interface 408 and the measurement core 402, the CPU 404 may provide processing services thereto including communication, memory management and arithmetic logic.

The measurement core 402 generally comprises a test access arrangement 414 and a common core 416. The test access arrangement 414 is provided with a measure section 414a and a configure section 414b. Likewise the a common core 416 is provides with a measure section 416a and a configure section 416b. The measurement sections 414a and 416a are configured receive measurements and record test results, while the configure sections 414b and 416b contain configuration data.

The test access arrangement 414 connects to the line under test. More specifically, the test access arrangement 414 interfaces with various customer measurement points. It is possible, and may be preferable, to utilize known test access arrangements, such as those associated with the AGILENT SERVICE ADVISOR TEST TABLET, to implement a variety of connections, such as lo-speed fiber, hi-speed fiber, coaxial cable, twisted pair, wireless, etc. . . . As is known to those of ordinary skill in the art, the test access arrangement 414 is specific to the configuration of line under test as different communication standards may use similar physical configurations but have vastly different signal requirements. The configuration section 414b stores a variety of parameters affecting the operation of the test access arrangement 414. For example, as both POTS and DSL comprise twisted pair lines it makes some sense to provide a test access arrangement 414 that is adaptable for both types of lines. However, there are various configuration issues between the two lines, for example, the bandwidth of test signals must be adjusted different for POTS and DSL lines. As another example, to seize a POTs line, one must “go off hook.” The functions required to go off hook are contained in configure section 414b of the test access arrangement 414. The test access arrangement 414 also provides necessary protection circuits to protect the test head 400 from damage due to surges, lightening strikes, etc. . . .

The common core 416 contains programmable logic (and as such can be physically implemented using the CPU 404 and the memory 406) that causes certain signals to be output by the test access arrangement 414 and causes certain signal processing operations to be performed on the signals received by the test access arrangement 414. The common core can be reconfigured by the CPU 404 to conduct a variety of test and measurement operations. Known common cores, such as those found in the AGILENT SERVICE TEST ADVISOR TABLET may be used to implement the common core 416. As us known to those of ordinary skill in the art, the physical construction for the common core 416 may vary with the type of line to be tested. For example, in a common core designed to test twisted pair wire, the common core 416 might comprise a signal processor, while in a common core designed to test a fiber optic line, the common core 416 might be a programmable logic device. The configure section 416b receives instructions, such as the memory descriptors in the SERVICE ADVISOR TEST TABLET that modify the behavior of the common core 416. Previously, such modifications were performed by connecting the test head to a local computer. The present invention permits such modification to take place via a network 206.

In prior test heads, commands and instructions were inputted directly through an onboard user interface, such as a keyboard and LCD screen. In accordance with the present invention, the test head 212 receives commands and data, including memory descriptors for the common core 416, via the network interface 408. The CPU 404 receives the commands and data from the network interface 408 and implements the requested actions, such as reprogramming of the common core, the instigation of tests contained in the common core and the reporting of measurement results stored in the measurement sections 414a and 416a. Preferably, the CPU 404 and a server (not shown, but could, for example, be the remote diagnostic unit 214 in FIG. 2) communicate with an XML based language, such as HTML using the hypertext transmission protocol (HTTP). Such communication can be implemented with a wide variety of readily available circuits and toolkits.

Referring once again to FIGS. 2 and 3, as the test and measurement functions are carried out, test head 212 transmits results to the network 206. In effect, the remote diagnostic application 214 interfaces with the test head 212 passing data, including command, thereto and receiving test and measurement results therefrom using any of a variety of known communication protocols, such as TCP/IP, HTML, and HTTP. Preferably, the remote diagnostic application incorporates a web server for interfacing with one or more computing device 216. Each computing device 216 is preferably a wireless handheld computing device, incorporating a web browser, permitting freedom of movement and ease of access, such as a PALM device or a POCKET PC device. Perhaps more preferably, a computing device 216 may comprise one of the many available digital cellular communication devices that includes PALM or POCKET PC functionality, such as the KYCOERA QCP 6035. Further, there is no requirement that each computing device 216 be the same. The computing device 216 is configured to communicate with the remote diagnostic application 214 so as to cause the issuance of commands to, and display of data generated by, the test head 212. In effect, the computing device 216 acts as the remote user interface for the test head 212.

Implementing such a remote user interface is facilitated by constructing the remote diagnostic application 214 as a web server serving web pages to the computing device 216. This enables a variety of devices, including PCs, Laptops, PDAs, cell phones, messaging devices, and other internet aware devices to serve as the computing device 216. The remote diagnostic application 214 may be formed using such software as: MICROSOFT Active Server Pages, server side scripting, VBscripts, JavaScripts, Jscripts, CGI scripts, Perl, Java program components and other assorted applets. The remote diagnostic application 214 can be run on a variety of operating system such as Windows XP, Windows 2000, Windows NT Server, OS X, UNIX, LINUX employing Apache or similar web server software. This permits the remote diagnostic application 214 and the computing device 216 to communicate with well known web based technologies, including HTML, XML, etc. via widely used protocols such as the Hyper-Text Transmission Protocol (HTTP). In such a configuration, the computing device 216 need only be able to act as a web browser, something which many PALM, POCKET PC, and cellular devices can do off the shelf.

While on-site, the tier one technician 210 performs the tests, in step 312, for which he has been trained, e.g. tier one tests. The tier one technician 210 may access the test head 212 through a computing device, facilitating freedom of movement, or, if provided, through an integrated I/O facility provided with the test head. If, in step 314 the tier one technician is unable to resolve the problem, an upper tier two technician 218 is contacted and assistance is requested. Subsequently, using their personal computing device 216, the tier two technician 218 accesses the functionality of the test head 212 via the remote diagnostic application 214 and conducts appropriate tests, for convenience termed “two tests,” in step 316. The computing device 216 permits technicians to view the output of the test head 212 in an attempt remotely diagnose problems outside the education/experience of the tier one technician 210 without the necessity of additional truck rolls. If the tier one technician 210 has stayed on site, the tier two technician 218 can suggest appropriate on-site measures which should be taken to resolve the problem. If the tier two technician is unable to resolve the problem in step 344, a tier three technician 320 is contacted and conducts appropriate test, for convenience termed “tier three tests” in step 320. As before, if the tier one technician 210 has stayed on site, the tier two technician 218 can suggest appropriate on-site measures which be should be taken to resolve the problem. The method ends in step 322.

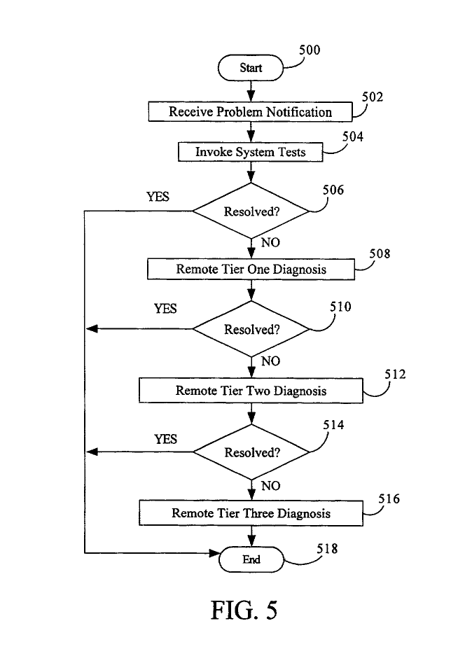

Once the test head 212 has been installed, it may be left on site to simplify future test and measurement procedures. FIG. 5 is a flowchart depicting a test and measurement procedure in accordance with another preferred embodiment of the present invention, applicable to the test and measurement system 200 shown in FIG. 2, wherein a test head 212 has been previously installed. The procedure starts in step 500 when a subscriber or customer initiates a service call received by the customer support desk 202 in step 502. Next, in step 504, an administrator attempts to resolve the reported trouble using system test procedures 204, typically accessed through a network 206. As previously noted, such system tests 204 have about a 90% success rate. If, in step 506, the system test 204 is unable to resolve the problem to the customer's satisfaction, a trouble ticket is generated by a trouble ticket application 208. In response to a first trouble ticket, a tier one technician 210 attempts, at step 508, to remotely diagnose the cause of the reported trouble. If the tier one technician 210 is comfortable with his diagnosis and ability to resolve the trouble, he implements a solution (either onsite or remotely, depending on the solution). If, in step 510, the tier one technician 210 can't diagnose and fix the problem he contacts a tier two technician 218 either by phone (pager) or by issuing a further trouble ticket. Next in step 512, the tier two technician 218 performs a remote tier two diagnosis. If, in step 514, the tier two technician 218 either can't diagnose the problem he contacts a tier three technician 220 either by phone (pager) or by issuing a further trouble ticket. Next in step 516, the tier three technician 220 performs a remote tier two diagnosis and implements a solution. The procedure ends in step 518. This method presents the possibility of resolving a problem with a truck roll.

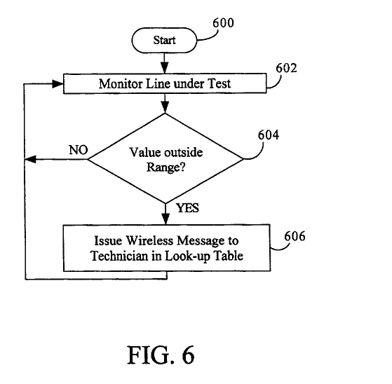

Depending on the configuration, a test head 212 left on site may be programmed to perform periodic and/or continuous monitoring. For example, the test head 212 may be configured, either by the tier one technician 210 or via the remote diagnostic application 214, for monitoring of a line being tested and when certain conditions are met, e.g. measurements result in certain values, a notification can be issued via the network 206, for example to a pager or cell phone (not shown) carried by the tier one technician 210. FIG. 6 is a flowchart depicting a test and measurement procedure for a test and measurement system in which a test head has been left on-site. The method starts in step 600. In step 602 a command is generated, either internally or externally, causing the test head 212 to initiate a pre-programmed monitoring procedure on the line under test. In step 604, if a value is generated that is outside a pre-determined range, or has some other definable state the method goes to step 606 and a wireless message is issued to a responsible technician, typically identified in a look up table. The identified technician can then institute a test and measurement procedure, for example: the method shown in FIG. 3B. The determination of an error condition may be performed by the test head 212 or the remote diagnostic application 214, although the latter may be the preferred configuration for ease of maintenance and updating.

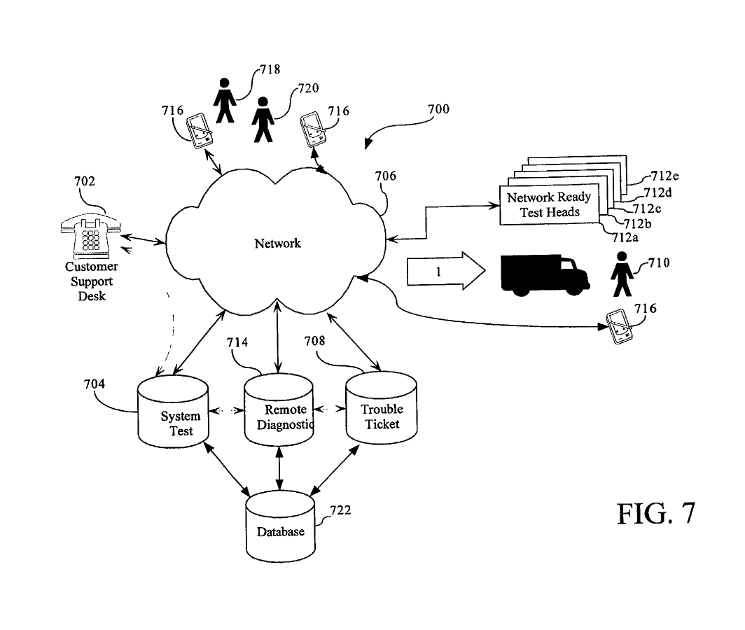

FIG. 7 is a system diagram of a test and measurement system 700 in accordance with a preferred embodiment of the present invention. It will be appreciated by those of ordinary skill in the relevant arts that the measurement system 700, as illustrated in FIG. 7, and the operation thereof is intended to be generally representative such systems and that any particular system may differ significantly from that shown in FIG. 7, particularly in the details of construction and operation of such system. As such, the test and measurement system 700 and method of use thereof is to be regarded as illustrative and exemplary and not limiting as regards the invention described herein or the claims attached hereto.

The test and measurement system 700 shown in FIG. 7 differs from the test and measurement system 200 in that a database 722 is provided to store and process data regarding the test and measurement process. Accordingly, the test and measurement system 700 is particularly suited for use with multiple network ready test heads, such as network ready test heads 712a through 712e. When a subscriber or customer initiates a service call received by customer support desk 702. Information about the call is logged into the database 722. As with the prior systems, an administrator attempts to resolve the reported trouble using system test procedures 704, typically accessed through a network 706. If the system test 704 is unable to resolve the problem to the customer's satisfaction, a trouble ticket is generated by a trouble ticket application 708. If a network ready test head 712n is not already installed at the customer site, the trouble ticket prompts the dispatch a tier one technician 710 to the trouble site for installation of the network ready test head 712n. Further, data regarding the trouble ticket is logged into the database 722.

The remote diagnostic application 714 interfaces with the test head 712n passing commands to and receiving data therefrom. The remote diagnostic application 714 also interfaces with computing devices 716, permitting the computing device 716 to issue commands for the test head 712n and to display data generated by the test head 712n. Under the direction of the tier one technician 710 (in the first instance), the tier two technician 718, and/or the tier three technician 720, a test and measurement process is carried out. The various test requested by the technicians 710, 716, and 720 along with the results thereto are stored in the database 722.

Depending on the configuration, a test head 712n left on site may be programmed to perform periodic and/or continuous monitoring. In this case, the results of the periodic monitoring may also be stored in the database 722.

Once data has been collected in the database 722, a variety of reports can be generated by those of ordinary skill in the art, such as case histories of particular communication lines, and effectiveness reports on particular technicians.

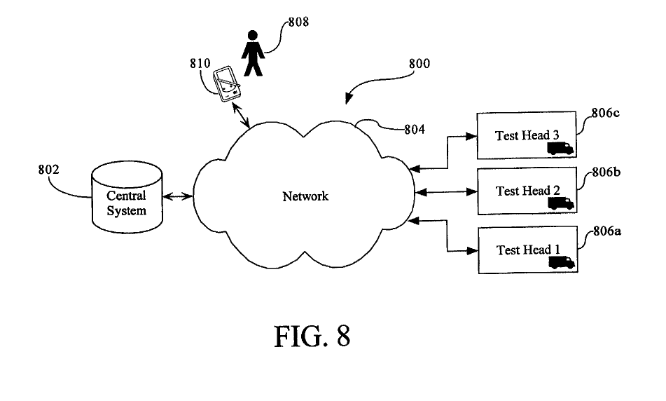

FIG. 8 is a system diagram of a test and measurement system 800 in accordance with another preferred embodiment of the present invention. Specifically, the system shown in FIG. 8 is useful for explaining a preferred delivery and use method of test heads. To focus on the delivery and use method, the computer resources associated with the central office are portrayed as a central server 802. The central server 802 is preferably a combination of software and hardware adapted to perform desired the functions previously ascribed to the customer support desk, the system test application, the remote diagnostic application, and the trouble ticket application.

The central server 802 is in communication with test heads 806a-806c and a computing device 810 via a network 804. A technician 808 is assigned responsibility for the three communication lines to be monitored by the test heads 806a-806c. It is envisioned that the technician 808 will be provided with, in this example, three trouble tickets for the three communication lines without test heads. The technician 808 will drive to a first location and install the first test head 806c. Upon completing installation, the technician 808 will contact the central office to place a test signal on the communication line associated with the first test head 808a using, for example wireless messaging via the computing device 810 or just a simple phone call. Instead of waiting for the central office to comply with the request, the technician 808 will proceed to the second location and install the second test head 806b. Upon requesting test signals on the second communication line, the technician 808 will proceed to the third location, install the third test head 806c and request a test signal on the third communication line.

As the central office configures each communication line (e.g. placing a test signal thereon) the technician 808 is informed by, for example, a wireless message to the computing device 810, a pager, a voice mail, or even just a simple phone call to his cellular phone. Because the interface for the each of the test heads 808a-808c is accessed through the computing device 810, the technician 808 can initiate any required test and measurement procedure and view the results thereof in real time and at any location. Further, because the technician 808 has installed the test heads at each site, diagnostic work can be performed by other technicians enabling parallel processing of the multiple sites, even though only one truck roll has occurred.

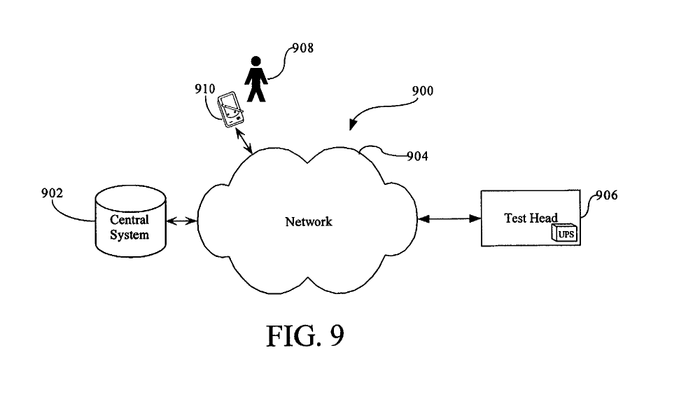

FIG. 9 is a block diagram of a test and measurement system 900 in accordance with a preferred embodiment of the present invention. Specifically, the system shown in FIG. 9 is useful for explaining a preferred delivery and use method of test heads. To focus on the delivery and use method, the computer resources associated with the central office are portrayed as a central server 902. The central server 902 is a combination of software and hardware adapted to perform desired the functions previously ascribed to the customer support desk, the system test application, the remote diagnostic application, and the trouble ticket application.

The central server 902 is in communication with test head 906 and a computing device 910 via a network 904. A technician 908 is assigned responsibility for the communication line to be monitored by the test head 906. The test head 906 is delivered to the customer site via a courier, such as the USPS, UPS, Federal Express, etc. . . . Instruction for installing the test head 906 are provided to the customer. There are a variety of possible forms that the instruction may take, for example an internet presentation, a brochure, a video, a phone call from a customer service rep, etc. . . . Upon completing installation, the customer or the test head 906 contacts the central office to initiate a trouble ticket notifying the technician 808 of the installation. The technician 808 then performs the required test and measurement procedures, such as requesting a test signal on the communication line. This delivery and use method may avoid costly truck rolls altogether. Such a system may be useful for simple network connections, such as home DSL lines.

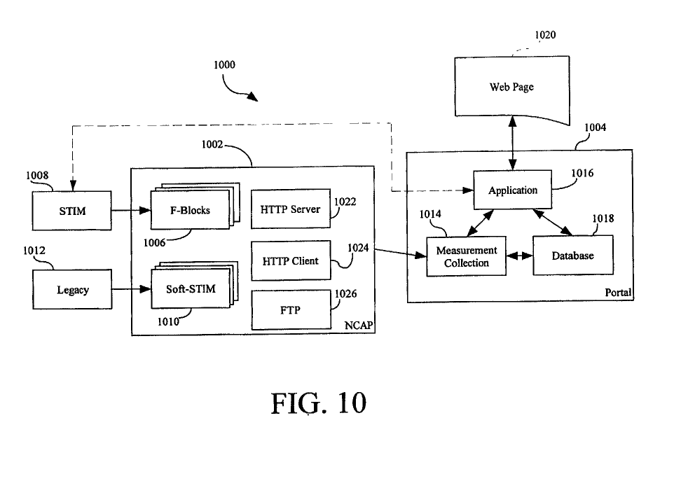

FIG. 10 is a block diagram of a test and measurement system 1000 in accordance with another preferred embodiment of the system. It has been found to be advantageous to implement the test head 400 in accordance with IEEE Std 1451.2-1997, IEEE Standard for a Smart Transducer Interface for Sensors and Actuators Transducer to Microprocessor Communication Protocols and Transducer Electronic Data Sheet, incorporated herein by reference. It has also been found advantageous to implement the test head 400 in accordance with IEEE Std 1451.1 -1999, IEEE Standard for a Smart Transducer Interface for Sensors and Actuators Network Capable application Processor (NCAP) Information Model, incorporated herein by reference.

The test and measurement system 1000 implements the IEEE 1451.1 and 1451.2 standards. The test and measurement system 1000 generally comprises a network capable applications processor 1002 (also referred to herein as an NCAP 1002) and a portal 1004. The applications processor 1002 is an abstraction of a measurement device and has a network connection including a http server 1022, an http client 1024, and an ftp server 1026 (for IP networks, this includes both a MAC and IP Address). Application logic can be downloaded into NCAP 1002 to perform tasks like measurement sampling, correlation, filtering, logging, etc. The http server 1022 stores a variety of web pages related to measurements, trend-charts, configure applications and network parameters, etc. . . . The http client 1024 sends data to the portal 1004 over port 80 as an http client. The ftp server 1026 provides remote access to local files.

Application processing is executed within the NCAP 1002 using C++ objects called function blocks (referred to herein as F-Blocks 1006). Such processing typically operates on measurement data and may generate new “derived” measurement values. F-Blocks 1006 are preferably a C++ base-classes that can be specialized through sub-classing. The following F-Blocks are provided as examples that can be created by those of ordinary skill in the art with available SDKs:Sampler:Responsible for scheduling measurements of 1451.2 channels at periodic intervals. Measurement results are published as Physical Parameters inside the NCAP 1002.

Limit: Responsible for monitoring measurement data streams and generating alarms. It also performs a decimation function to limit how frequently data gets passed onto the Portal. This allows the Sampler to over-sample a gives more responsive alarm detection.

Reporter: Manages all communications with the Portal 1004. The reporter batches messages together, maintains the heart-beat interval, handle live-measurement mode, and other back-channel issues.

The test and measurement system interfaces with a smart transducer interface module 1008 (also referred to herein as a STIM 1008). The STIM 1008 is the Measurement front-end and is composed of a set of Measurement Channels. Each STIM 1008 connects to the NCAP 1002 over an transducer independent interface (referred to as an TII), a 10 wire digital connection. A STIM 1008 corresponds to the measurement core 402 in FIG. 4. Typically, the STIM 1008 contains a small microprocessor like a Microchip PIC or Analog Devices ADuC812. Inside the NCAP 1002, a 1451.2 driver F block 1006 manages all communication. Applications make measurements by interacting with STIMS through 1451.2 APIs. In accordance with the preferred embodiment of the present invention each STIM 1008 can receive data including programmable logic commands directly from the applications 1016.

Legacy devices 10012 can be interfaced using a software-only STIM 1010 which provides a mechanism to add software drivers to communicate with non-1451.2 measurement devices. basically soft-STIMs 1010 interface with the legacy measurement device 1012 and output a data stream which adheres to the 1451.2 API. The nature of this communication is quite flexible, for example the following represent some of the range of devices that can be interfaced using soft-STIMs 1010:Modbus devices over a multi-drop RS485 network. Each Modbus device is modeled as a separate STIM. Up to 32 Modbus devices can be supported. The Modbus binary master/slave protocol is supported.

Interfacing to a measurement device over an RS232 cable. For example, the Motorola base-station provides such an RS232 interface. Key parameters maintained by the base-station (e.g. number of GPS satellites being tracked) are presented through 1451.2 channels.

Interfacing to a networked device over Ethernet. For example, the HP89400 provides a TCP/IP connection to its SCPI parser. The Soft-STIM communicates to the parser to perform measurements. Measurement results are reflected as 1451.2 channels. This same approach has been demonstrated with devices that provide custom web pages. Data from such web pages are reflected as 1451.2 channels.

Interfacing to a software-only measurement. For example, the NCAP's time-synchronization protocol maintains statistics on its synchronization accuracy, the identity of the master clock, etc. This data is represented as 1415.2 channels.

The portal 1004 roughly corresponds to the system test application 204, the remote diagnostic application 214 and the trouble ticket application 208. Inside the portal 1004, physical parameters communicated via a 1451.2 channel and are combined together into application specific data structures termed measurement collections 1014. Measurement collections 1014 are presented to applications 1014 (such as a system test application 204, a remote diagnostic application 214 and a trouble ticket application 208) using application specific data structures. To implement periodic testing procedures described above, applications 1014 can register interest in such collections and will be notified when they are updated. Users interact with the application 1014 through web browsers 1020. In accordance with the teachings set forth above, a database 1018 may also be provided to gather, organize and store the measurement collections 1014 for reporting to an application 1016.

Although a few embodiments of the present invention have been shown and described, it will be appreciated by those skilled in the art that changes may be made in these embodiments without departing from the principles and spirit of the invention, the scope of which is defined in the claims and their equivalents.

1. A method of testing a communication line comprising:
establishing a wireless communication link between a server and a hand carried communication device;
establishing a communication link between the server and a test and measurement device connected to the communication line;
using the hand carried communication device to instruct server to send a message to the test and measurement device causing the test and measurement device to conduct a test on the communication line and report the results to the server; and
providing an indication of the results on the hand carried communication device.

2. A method, as set forth in claim 1, wherein the step of establishing a communication link between the server and a test and measurement device connected to the communication line comprises establishing a wireless communication link between the server and the test and measurement device connected to the communication line.

3. A method, as set forth in claim 1, further comprising:
dispatching a technician to a site to connect the test and measurement device the communication line.

4. A method, as set forth in claim 1, further comprising:
mailing the test and measurement unit to a customer and providing instructions on how to connect the test and measurement device the communication line.

5. A method, as set forth in claim 1, further comprising:
periodically testing the communication line with the test and measurement device;
if, during the periodic testing, a result satisfies a predetermined condition notifying a technician using a wireless device.

6. A method, as set forth in claim 1, further comprising:
periodically testing the communication line with the test and measurement device;
if, during the periodic testing, a result satisfies a predetermined condition automatically issuing a trouble ticket.

7. A method, as set forth in claim 1, further comprising:
establishing a wireless communication link between the server and a second hand carried communication device;
using a second hand carried communication device to instruct server to send a message to the test and measurement device causing the test and measurement device to conduct a test on the communication line and report the results to the server; and
forwarding the results from the server to the second hand carried communication device;
displaying the results on the second hand carried communication device.

8. A method, as set forth in claim 7, further comprising:
distributing the first hand carried device to a tier one technician; and
distributing the second hand carried device to a tier two technician.

9. A method, as set forth in claim 1, wherein the step of establishing a wireless communication link between a server and a hand carried communication device comprises:
providing a web server on the server;
providing a web browser on the hand carried communication device;
transmitting information between the web server and the web browser using hypertext transmission protocol.
